(19) United States
(12) Patent Application Publication
(10) Pub. No.: US 2004/0064405 A1
(43) Pub. Date: Apr. 1, 2004

(54) Methods and systems for processing partial payments using debit cards

(75) Inventors: Margaret Morgan Weichert, San Carlos, CA (US); John Joseph Mascavage, San Mateo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/262,530

(22) Filed: Sep. 30, 2002

(51) Int. Cl. G06F 17/60

(52) U.S. Cl. 705/39

(57) ABSTRACT

Methods and systems are provided for processing transactions between a vendor and a purchaser. A payment system is provided in communication with the vendor, a financial institution that holds a vendor account on behalf of the vendor, and a financial institution that holds a purchaser account on behalf of the purchaser. The payment system collects funds from the purchaser account and holds them in a vendor account, distributing funds for individual partial shipments as they are made by the vendor.

### BACKGROUND OF THE INVENTION

This application relates generally to methods and systems for processing payments using debit instruments. More specifically, this application relates to methods and systems for processing partial payments using debit instruments.

In recent years, there has been a persistent increase in the use of electronic mechanisms to effect commercial transactions. One example in which this is particularly evident is in commercial transactions that take place over the Internet, although electronic mechanisms are also used in other commercial transactions, both where the parties are remote from each other and where the parties are together. In a typical Internet transaction, a customer orders goods from a commercial web site and provides funds for the transaction by supplying credit-card information. A check is made by the seller of the goods that the credit-card information is valid and that sufficient credit is available to support the transaction. The credit card is then charged for the amount of the transaction and the goods are shipped to the purchaser.

In some instances, the seller uses multiple shipments to ship the requested goods. There are various reasons why multiple shipments may be used. For example, there may be fluctuations in inventory so that some goods are available at different times from other goods. In some instances, different types of goods may be warehoused at different locations so that even goods shipped to a single individual do not necessarily originate from the same location. When multiple shipments are made, customers are generally willing only to accept charges made against the purchaser's credit card for the amount of each shipment as that shipment is made.

It is desirable to permit electronic transactions to be effected using debit instruments, such as debit cards, which differ from credit cards in that execution of the transaction results in the immediate withdrawal of funds for the transaction from a financial account. In some cases, a card may be capable of initiating both debit and credit functions; when a card has such a capability, it usually includes a logo for the credit provider. If such a card is used for credit, the transaction information is routed through the relevant credit-card network. If it is used instead as a debit instrument, the transaction information is used to access funds directly from the identified financial account.

There are a large number of individuals that do not have access to credit cards, so that a limitation to credit-card arrangements reduces the overall transaction volume that might otherwise be available. Moreover, there is a financial incentive for businesses to accept debit cards since transaction fees associated with debit cards are typically lower than transaction fees associated with credit cards. These reductions in transaction costs may also be passed onto consumers. Despite these benefits, the possibility of having to process a transaction in multiple portions to accommodate multiple shipments acts as a significant impediment to a seller's willingness to accept a debit card for the transaction. This impediment derives primarily from the fact that, at the time of the transaction, the seller has no way of determining whether sufficient funds will be available in the purchaser's account at the time of shipment.

There is accordingly a general need in the art for methods and systems that permit the use of debit instruments for processing partial payments that accounts for the concerns of both customers and sellers.

### BRIEF SUMMARY OF THE INVENTION

Embodiments of the invention thus provide methods for processing transactions between a vendor and a purchaser. In such embodiments, a payment system may be integrated into a transaction architecture, with the payment system being in communication with at least the vendor, a financial institution that holds a vendor account on behalf of the vendor, and a financial institution that holds a purchaser account on behalf of the purchaser. The payment system may collect funds from the purchaser account and hold them in a surrogate account, distributing funds for individual partial shipments as they are made by the vendor. Alternatively, the payment system may use a risk-analysis system to evaluate the probability that the purchaser account will contain sufficient funds to cover partial shipments when they are made, with the payment system also coordinating transfers directly from the purchaser account to the vendor account as the shipments are made.

In one set of embodiments, payment information for the transaction is received by the payment system. The payment information may include debit information that identifies the purchaser account and may also include an identification of the vendor account. When the vendor makes a partial shipment in accordance with the transaction, notification of such a partial shipment is received by the payment system. The payment system then effects a transfer of funds from the purchaser account to the vendor account in accordance with the partial shipment. Such a transfer may comprise a transfer from the purchaser account to a surrogate account controlled by the payment system and a transfer from the surrogate account to the vendor account. The transfer from the purchaser account to the surrogate account may be performed before notification is received of the partial shipment, such as at the time the transaction is arranged, and the transfer from the surrogate account to the vendor account may be performed after notification of the partial shipment is received. In such instances, the transfer from the purchaser account to the surrogate account may be of a total payment for the transaction while the transfer from the surrogate account to the vendor account is only for a partial payment amount for the partial shipment. In instances where a time period passes, such as a time period between successive partial shipments, funds may be returned from the surrogate account to the purchaser account.

In other instances, the transfer from the purchaser account to the vendor account may be performed directly. Such a direct transfer may be performed after receiving notification of the partial shipment from the vendor. In instances where such a transfer mechanism is used, the payment system may perform a risk assessment of a funds level in the purchaser account, such as to evaluate the likelihood that funds will be available in the purchaser account when notification of a partial shipment is received.

In another set of embodiments, a transaction with a purchaser is processed. An identification of a plurality of items is collected from the purchaser, as is debit information that identifies a purchaser account associated with the purchaser. The debit information is provided to a payment system. Through coordination by the payment system, funds are received in response to a shipment of a portion of the plurality of items. In some instances, the funds are received directly from a surrogate account controlled by the payment system while, in other instances, funds are received directly from the purchaser account.

In all of these embodiments, the debit information may be received from a debit card, may be received from a computer-readable storage medium, and/or may comprise encrypted information. In addition, the debit information may be collected from various different sources, including over the Internet and with a point-of-sale device.

The methods of the invention may be performed by a computer system having an input interface, an output interface, and a processor in communication with the input and output interfaces, with the processor configured to execute such methods.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A is a block-diagram representation of an arrangement for processing payments using debit cards in an embodiment of the invention;

FIG. 1B is a schematic representation of an embodiment of a debit-card transaction process using the arrangement shown in FIG. 1A;

FIG. 1C is a flow diagram of an embodiment of the debit-card transaction process that corresponds generally to the representation of FIG. 1B;

FIG. 2 is a block-diagram representation of another arrangement for processing payments using debit cards in another embodiment of the invention;

FIG. 3A is a block-diagram representation of a further arrangement for processing payments using debit cards in a further embodiment of the invention;

FIG. 3B is a flow diagram of an embodiment of a debit-card transaction process using the arrangement shown in FIG. 3A; and

FIG. 4 is a schematic illustration of a computer system on which methods of the invention may be embodied.

### DETAILED DESCRIPTION OF THE INVENTION

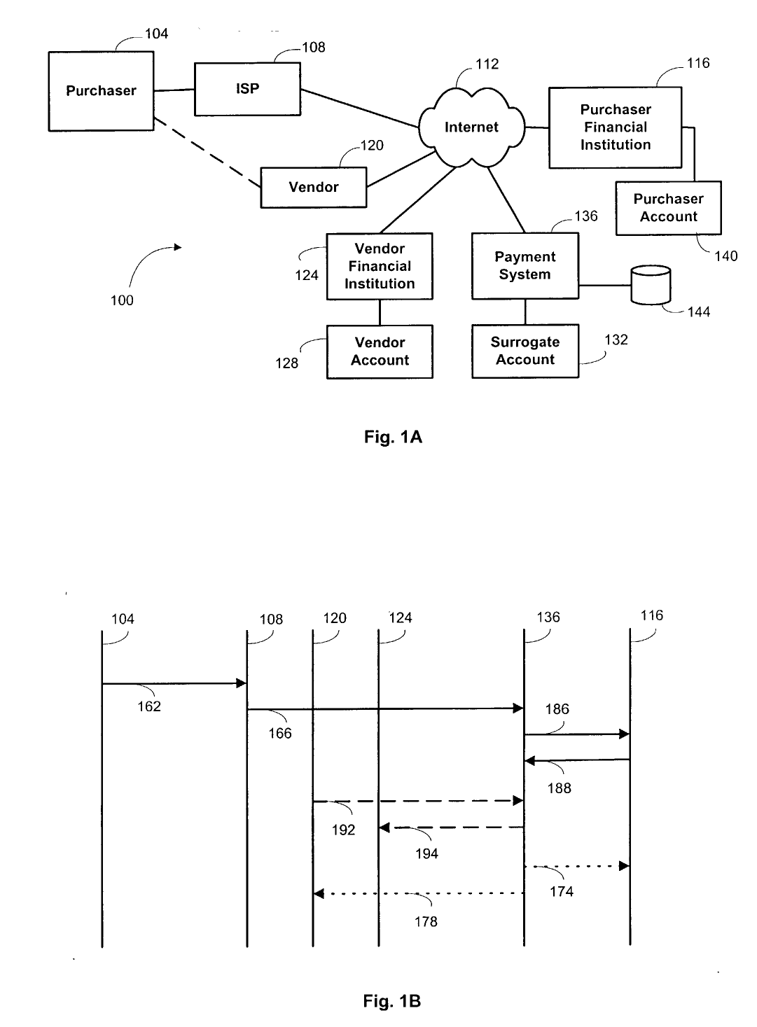

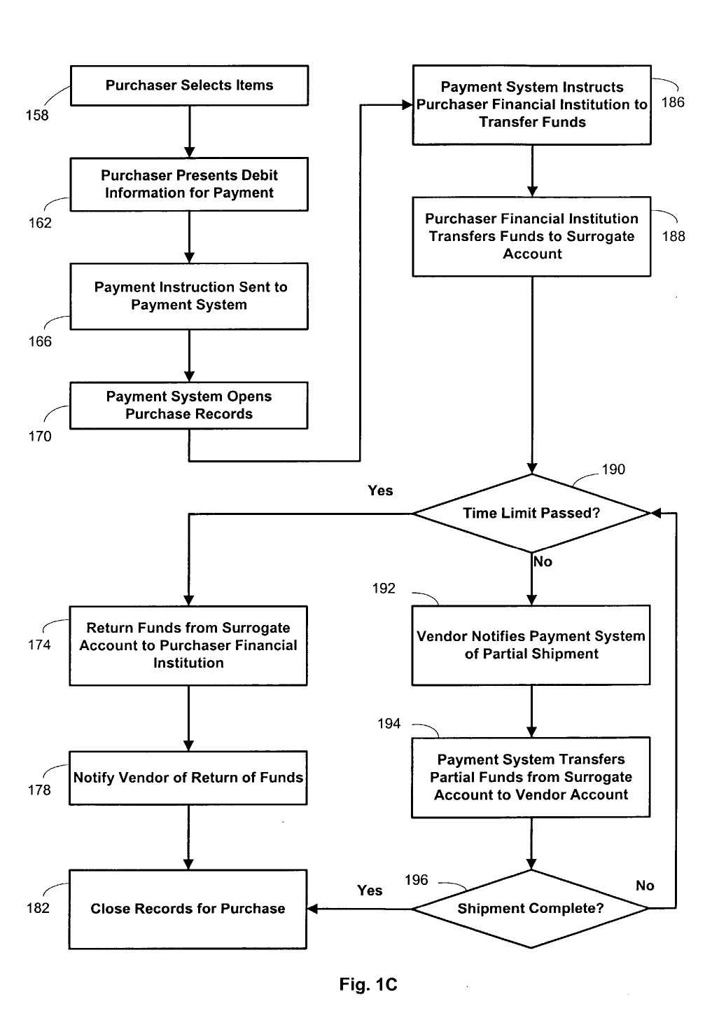

Embodiments of the invention provide a method and system for processing payments made with debit instruments, including payments for transactions that are satisfied with multiple shipments. The basic structure of an embodiment is initially provided in FIGS. 1A-1C for an Internet-based transaction, although, as explained more fully below, embodiments may alternatively be used for a transaction with any type of origination, including in-person transactions.

Embodiments of the invention integrate a payment system within a transaction architecture, with the payment system being configured to act as an intermediary between the vendor and the purchaser. In the embodiment illustrated with FIG. 1A, the transaction architecture is denoted generally by reference numeral 100. The payment system 136 coordinates transactions by collecting all of the funds for a transaction from the purchaser at the time of the transaction, and releasing those funds in portions as partial shipments are made by the vendor. The funds collected and released by the payment system 136 are held in a surrogate account 132 that is under the control of the payment system 136. In some embodiments, a single surrogate account 132 is maintained by the payment system 136, with records maintained in an associated database 144 to define which funds in the surrogate account 132 correspond to which transactions. In other embodiments, multiple surrogate accounts 132 are maintained. According to one organization, each of such multiple accounts corresponds to a specific vendor or group of vendors, although other organizations may alternatively be used.

The payment system 136 is provided in communication with the Internet 112, which also provides a means for communication between a specific purchaser 104 and a specific vendor 120. The purchaser 104 may connect to the Internet 112 through an Internet-service provider 108. In addition to providing communication between the purchaser 104 and vendor 120 to initiate a transaction, the Internet 112 provides connections between the payment system 136, a purchaser financial institution 116, and a vendor financial institution 128. Each of the purchaser and vendor financial institutions 116 and 124 may generally comprise any institution that maintains financial accounts on behalf of parties, including not only banks, credit unions, and other institutions that maintain currency-based accounts, but also institutions that maintain non-currency-based accounts, such as investment institutions and the like. While the description below focuses on an embodiment in which the surrogate account 132 is provided under the control of a payment system, it will be appreciated that access to the surrogate account 132 may be provided differently in alternative embodiments. For example, in one such alternative embodiment, the surrogate account is maintained by the purchaser financial institution 116. In another such alternative embodiment, the surrogate account is maintained by the vendor financial institution.

The purchaser financial institution 116 maintains a purchaser account 140 on behalf of the purchaser 104, and is characterized by the fact that it enables the purchaser 104 to permit real-time debits of the purchaser account 140 electronically as part of a transaction. Usually, such capability is subject to the satisfaction of certain security protocols to confirm the identity of the purchaser 104. For example, in one embodiment, the ability of the purchaser 104 to permit such real-time debits is enabled by the issuance of a debit card. The debit card includes encoded information, such as on a magnetic stripe, identifying the purchaser account 140 and identifying the purchaser 104, such as with a personal identification number (“PIN”) issued separately to the purchaser 104. Other identification mechanisms may be used in other embodiments, such as through the use of biometric identification techniques, including hand-geometry identifications, fingerprint identifications, voice-pattern identifications, retinal identifications, and the like. In other embodiments, real-time debits from the purchaser account 140 may be enabled by the issuance of a smart card that at least incorporates functions similar to those described for a debit card. In still other embodiments, other mechanisms may be used, such as by providing a stored-value card, with the purchaser account 140 corresponding to the funds stored on the card, coupled with information for a return of funds to the purchaser 104 if appropriate as part of the methods described below. The vendor financial institution 124 similarly maintains a vendor account 128 into which funds for the transaction are to be deposited as shipments are made.

In some embodiments, the purchaser and vendor accounts 140 and 128 may hold different types of value. In such instances, the payment system 136 may be equipped with a value-exchange engine that permits conversion of the value in a manner similar to that described in copending, commonly assigned U.S. patent application Ser. No. 09/955,747, entitled “METHODS AND SYSTEMS FOR TRANSFERRING STORED VALUE,” filed Sep. 18, 2001 by Kurt Hansen et al., the entire disclosure of which is incorporated herein by reference for all purposes. Such a value-exchange engine permits the support of a more flexible array of transaction types that the purchaser 104 may initiate. For example, if a purchaser 104 wishes to purchase an item from a vendor 120 using accumulated frequent-flyer points, the value-exchange engine comprised by the payment system 136 may be used to exchange the different value types. Merely by way of example, the purchaser financial institution 116 might be an airline that maintains frequent-flyer points for the purchaser 104 and the vendor financial institution 124 might be a bank that only maintains currency-based accounts. Including a value-conversion capability with the payment system 136 is convenient since it permits the vendor 120 to advertise such a capability without the burdens of its implementation, a feature that may be especially desirable when the business of the vendor 120 is relatively focused.

FIGS. 1B and 1C depict the implementation of a typical transaction that uses the architecture 100 shown in FIG. 1A. FIG. 1B schematically shows the flow of instructions or funds within the architecture 100 and FIG. 1C provides a flow diagram that details a specific implementation in an embodiment. The solid-line arrows in FIG. 1B correspond to the initial blocks in FIG. 1C, which provide for the initiation of a transaction. Typically, Such a transaction is initiated by the purchaser 104 at block 158, who selects items to be purchased from the vendor 120. In one embodiment, this is done through a web-based interface supplied by the vendor 120 through the Internet 112. The interface provides a selection of goods and/or services offered by the vendor 120, with a mechanism for selecting which goods and/or services the purchaser 104 wishes to purchase. As used herein, the term “items” is thus intended to refer collectively to goods and/or services. The interface provides a total amount that is to be paid by the purchaser 104 for the items selected. This total amount may be adjusted upwards from the list price of the items to account for service charges imposed by the vendor 120 and/or by the payment system 136. The total amount may also be adjusted downwards from the list price if valid coupons or other forms of rebates are provided by the purchaser 104 at the time the transaction is initiated to reduce the overall cost.

Once the purchaser 104 has made a selection of items, he presents debit information at block 162. Such debit information includes sufficient information to obtain funds in real time from the purchaser account 140, such as by providing debit-card information. It is generally sufficient to provide an identifier to the payment system 136 that identifies which accounts are to be debited and which are to be credited. While it is often preferred that this information be encrypted for security purposes, such encryption is not required. In some embodiments, this information may be provided in a secure fashion that does not require the purchaser 104 to supply his PIN. Some methods for doing so are described in WO01/18729, entitled “SYSTEM AND METHOD FOR PROVIDING SECURE SERVICES OVER PUBLIC AND PRIVATE NETWORKS USING A REMOVABLE, PORTABLE COMPUTER-READABLE STORAGE MEDIUM AT A NETWORK ACCESS DEVICE,” published Mar. 15, 2001, the entire disclosure of which is incorporated herein by reference in its entirety for all purposes. According to these methods, financial services are provided by using a portable computer-readable storage medium as a substitute for a more traditional debit card. As a counterpart to a traditional debit card, this computer-readable storage medium includes information similar to that contained on the magnetic stripe of a debit card, including an identification of the purchaser account 140, but is further encrypted. This arrangement permits the computer-readable storage medium to be used for electronic transactions in a manner similar to how the debit card is used. When the purchaser 104 uses the computer-readable storage medium to present debit information at block 162, a microprocessor in the purchaser's 104 personal computer (or other device) retrieves the encrypted information for use in the same fashion as debit-card information.

An identification of the selections made by the purchaser 104 is combined with the debit information so that a payment instruction is transmitted to the payment system 136 at block 166. If the payment instruction includes encrypted information, such as might by received by the payment system 136 when the methods disclosed in WO01/18729 are used, it is decrypted by the payment system 136. The payment instruction contains sufficient information to identify at least the purchaser account, the vendor account, and the total amount of the transaction. At block 170, the payment system opens purchase records to maintain this information in the database 140. These records may additionally be updated periodically as shipments are made by the vendor 120 in accordance with the purchase.

At block 186, the information in the payment instruction is used to instruct the purchaser financial institution 116 to transfer funds from the purchaser account 140 equal to the total amount identified to the purchaser 104 after accounting for service charges and/or applicable rebates. In response to this instruction, at least a portion of the funds are transferred to the surrogate account 132 maintained by the payment system 136 at block 188. In embodiments where there is no initial partial shipment of items at the time of the transaction, the total amount is transferred from the purchaser account 140 to the surrogate account at block 188. In other embodiments where the vendor 120 is prepared to make a partial shipment at the time of the transaction, however, a portion of the funds that corresponds to that partial shipment may be transferred directly by the purchaser financial institution 116 to the vendor financial institution 124 for deposit in the vendor account 128, with the remainder of the funds transferred to the surrogate account 132.

After this initial set up, the payment system 136 awaits confirmation that shipments have been made by the vendor 120 so that proportional funds may be released from the surrogate account 132 for deposit in the vendor account 128. In some embodiments, a maximum time limit is imposed on the shipments, after which funds are returned to the purchaser. The time limit may represent a limit between shipments or may represent an absolute time limit measured from when funds were initially transferred from the purchaser account 140 at block 188. Thus, at block 190, a check is made to determine whether that time limit has passed. The long-dashed arrows in FIG. 1B correspond to functions that are performed if the time limit has not been exceeded and the short-dashed arrows in FIG. 1B correspond to functions that are performed if the time limit has been met or exceeded. The passage of a time period is merely an example of a condition that may be satisfied upon which funds are returned to the purchaser. In other embodiments, satisfying a different condition, such as an action taken by the purchaser, may trigger a return of funds to the purchaser.

If the time limit has not yet passed, further action by the payment system 136 is initiated by receipt of notification from the vendor 120 at block 192 that a partial shipment of the order for goods has been made. The payment system 136 responds to such notification by determining how much of the funds remaining in the surrogate account 132 for the corresponding transaction are applicable to the partial shipment. This determination is made by retrieving transaction records from the database 144 and correlating those records with the content of the partial shipment. Funds appropriate for the partial shipment are then transferred from the surrogate account 132 to the vendor account 128 at block 194. After effecting the transfer, a check is made at block 196 to determine whether all of the items requested by the purchaser 104 have been shipped so that the transaction is complete. If so, the records for that transaction are closed at block 182. If the transaction is not complete, the payment system 136 continues to await a further shipment or passage of the time limit at block 190. In different embodiments, service charges for the payment system 136 may be collected at different points in the process. For example, a service charge may be collected at block 188 when funds are initially transferred from the purchaser account 140, at block 194 for each partial shipment, and/or at block 182 after the entire transaction has been executed.

If, as checked at block 190, the imposed time limit has passed without a shipment from the vendor 120, the payment system 136 returns funds that remain in the surrogate account 132 to the purchaser financial institution 116 at block 174 for deposit in the purchaser account 140. The vendor 120 is notified at block 178 that the funds have been returned so that alternative arrangements may be made between the vendor 120 and purchaser 104 if future shipment of remaining items remains possible. At block 182, records for that transaction are then closed.

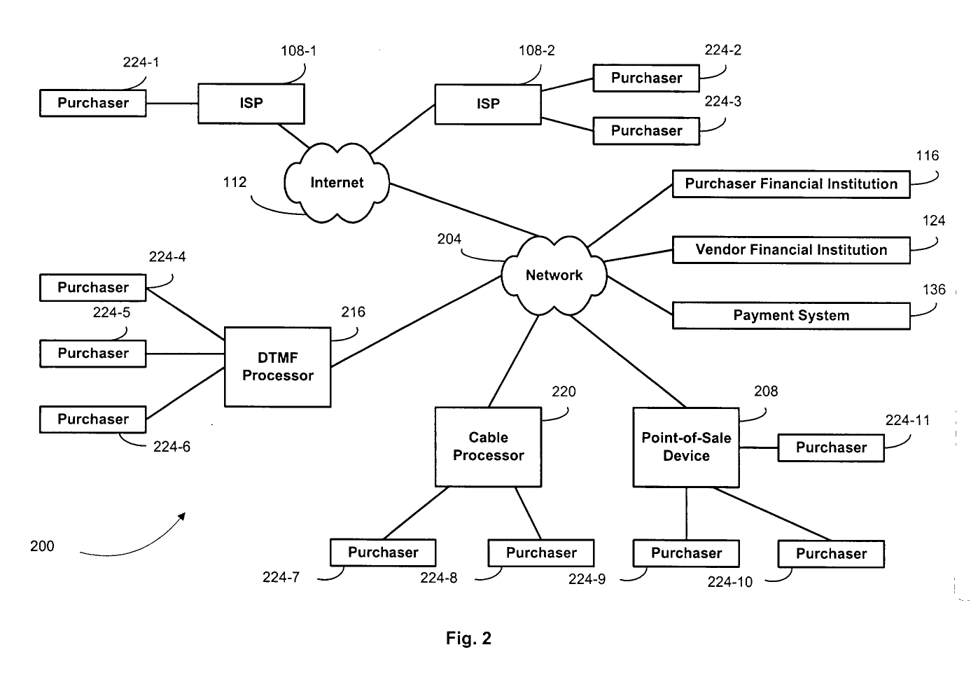

While the above description has focused specifically on an application in which the transaction originates over the Internet, it will be appreciated that this is not a requirement and that, more generally, the transaction may originate in any fashion. For example, a purchaser may use a telephone-ordering service to place an order with the vendor through a telephone representative. This is indicated schematically in FIG. 1A with the dashed line between the purchaser 104 and the vendor 120. In such an embodiment, the telephone representative collects the identification of the items and the debit information from the purchaser, and forwards such information to the payment system. In other embodiments, such as shown in FIG. 2, the architecture 100 of FIG. 1A is integrated into a larger, more versatile architecture 200. In this larger architecture 200, the purchaser financial institution 116, vendor financial institution 124, and payment system 136 retain the capability to communicate with each other. This is achieved, however, with a network 204 that is in communication not only with the Internet 112, but also with processors that permit communication with purchasers 224 through a telephone connection, a cable connection, or with a point-of-sale device such as might be used at a physical store.

FIG. 2 provides a number of examples of how purchasers 224 may interact with the architecture 200 to arrange transactions on a debit basis that apply the methods described with respect to FIG. 1C. In some of these interactions, the purchasers 224 are remote from the vendor and in other interactions, the purchasers 224 may be at the same location as the vendor (or one of its representatives). Purchasers 224-1, 224-2, and 224-3 interact with the architecture 200 in a fashion similar to that described with respect to FIG. 1A, using an Internet connection through an Internet-service provider 108. Two separate Internet-service providers 108 are illustrated, with purchaser 224-1 interacting with the architecture 200 through a first Internet-service provider 108-1 and purchasers 224-2 and 224-3 interacting with the architecture 200 through a second Internet-service provider. Purchasers 224-4, 224-5, and 224-6 interact with the architecture 200 through a dual-tone multiple-frequency (“DTMF”) processor 216, which permits transactions to be initiated through touch-tone telephone signals. Purchasers 224-7 and 224-8 interact with the architecture 200 through a cable processor, which permits transactions to be initiated through signals generated from a cable connection. The Internet, DTMF, and cable connections are examples of mechanisms that enable purchasers 224 to initiate transactions remotely. Other examples of such remote interactions will also be evident to those of skill in the art after reading this description.

Purchasers 224-9, 224-10, and 224-11 may interact with the architecture 200 at a vendor location by providing debit information to a point-of-sale device 208. Such a point-of-sale device 208 may include associated equipment, devices, and the like that are used in executing a transaction. Such equipment may include data-entry components, signature-capture components, key pads, keyboards, display screens, biometric data capture components, speakers, printers, processors, software, memory, communication devices and the like. Examples of suitable point-of-sale devices 208 are described in detail in copending, commonly assigned U.S. patent application Ser. No. 10/116,689, entitled “SYSTEMS AND METHODS FOR PERFORMING TRANSACTIONS AT A POINT-OF-SALE,” filed Apr. 3, 2002 by Earney Stoutenburg et al., the entire disclosure of which is herein incorporated by reference for all purposes. The method outlined with respect to FIG. 1C may thus be performed as part of an in-person transaction. For example, a purchaser 224 may select various items in a store, but be unable to accept delivery of them at that time, perhaps because the items are out of stock, or the store includes only floor models with the specific items ultimately delivered being stored in a warehouse. The purchaser 224 may nevertheless execute the transaction at the store by presenting debit information as at block 162 in FIG. 1C through the point-of-sale device 208. This may be done by using a magnetic-stripe-reading capability or a smart-card-reading capability of the point-of-sale device, among other techniques. Subsequent processing of such an in-person transaction takes place in the same fashion as described with respect to FIG. 1C.

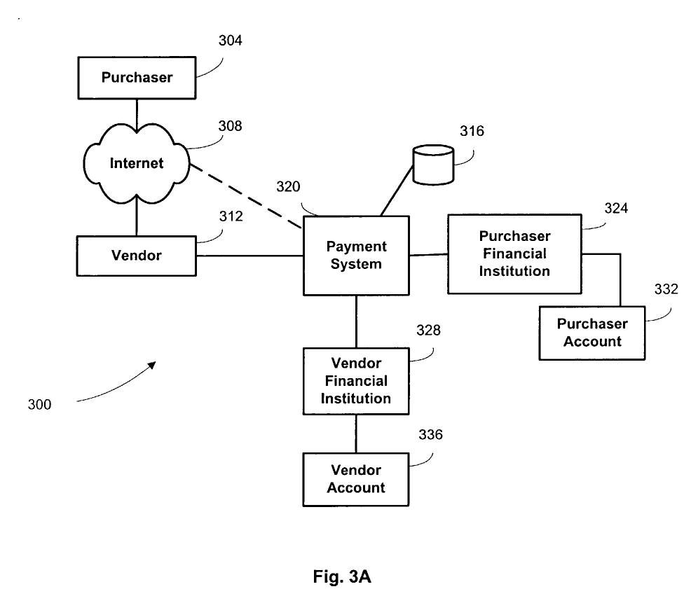

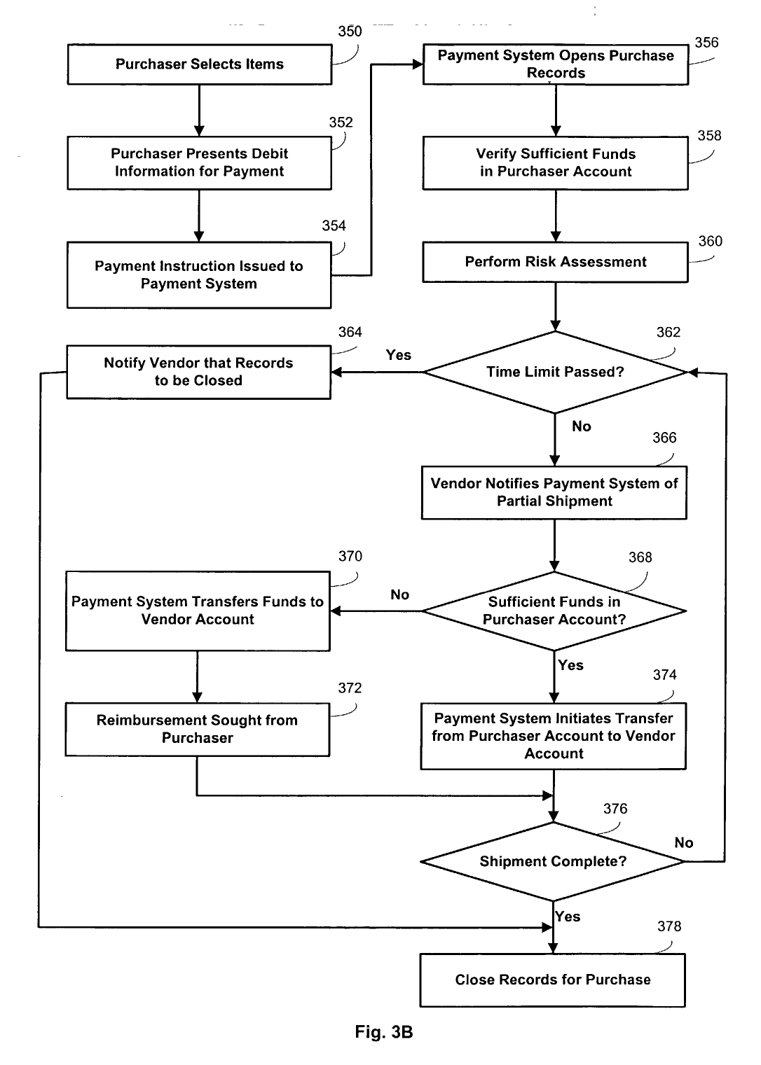

In another embodiment of the invention, the payment system may avoid the use of a surrogate account so that funds for partial shipments remain under the control of the purchaser until such partial shipments are made. An architecture for such an embodiment is illustrated schematically in FIG. 3A and an implementation is illustrated with a flow diagram for a specific method in FIG. 3B. For simplicity, the architecture 300 shown in FIG. 3A illustrates the principles used in these embodiments by having the purchaser 304 interface with the vendor 312 over an Internet connection 308. More generally, however, different techniques, including those discussed in connection with FIG. 2, may be used by the purchaser 304 to initiate the transaction. In the architecture shown in FIG. 3A, the payment system 320 is configured to be in communication with the vendor 312, the vendor financial institution 328, and the purchaser financial institution 324. As shown by the dashed line, in some instances the payment system 320 may also be in communication with the Internet 308, permitting direct communication between the payment system 320 and the purchaser 304. In other instances, no such direct communication is provided, with information regarding the purchaser 304 being provided by the vendor 312. The payment system 312 is also connected with a database 316 for storing information relevant to managing the partial payments, which are initiated by issuing instructions to effect a transfer from the purchaser account 332 to the vendor account 336. The purchaser account 332 is maintained by the purchaser financial institution 324 for the purchaser 304 and the vendor financial account 336 is maintained by the vendor financial institution 328 for the vendor 312. While these accounts may each hold currency-based value, in other instances they may hold other types of value, with the payment system 320 being equipped with a value-exchange engine to convert different forms of value as discussed above in connection with FIG. 1A.

In the flow diagram of FIG. 3B, the first four blocks of the exemplary method are similar to those shown in FIG. 1C. In particular, the method begins with the selection of items by the purchaser 304 at block 350. Such selection may be done remotely by using an interface such as an Internet web-based interface or may be done in person at a vendor location. The purchaser 304 presents debit information for payment of the items at block 352. Such presentment may be provided in any of the forms previously discussed, including providing debit-card information over the Internet 308, using a computer-readable storage medium containing encrypted debit information as discussed in WO01/18729, or through the use of a debit card at a point-of-sale device, among other means for presentment. Such debit information is combined with an identification of the total amount for the items to produce a payment instruction that is issued to the payment system 320 at block 354. The payment system 320 opens purchase records, storing relevant information in the database 316, to process partial payments for the transaction at block 356.

At this point in the method, the information supplied to the payment system 320 in FIG. 3B is equivalent to the information provided for the method illustrated with FIG. 1C. From the perspective of the services received by the vendor 312, the method shown in FIG. 3A is thus equivalent to the method shown in FIG. 1C. Rather than transfer funds into a surrogate account, however, the payment system 320 initially verifies at block 358 only that sufficient funds are available in the purchaser account 332 to pay for the entire transaction. If there are sufficient funds, the payment system 320 then performs a risk assessment at block 360 to evaluate a probability that sufficient funds will continue to reside in the purchaser account 332 when a partial shipment is subsequently made. Such a risk assessment may be performed in a variety of different ways and at different levels of complexity using different types of risk factors. For example, in a simple embodiment, the risk assessment may rely solely on a credit score for the purchaser 304. In other embodiments, additional information such as income level, balance history for the purchaser account, demographic information, and the like may be used in a risk model to assess the risk level by correlating these different factors. Such a risk model may use a static model or may use a more dynamic model that incorporates an expert system, neural network, genetic algorithm, or any other type of dynamic modeling technique known to those of skill in the art. If the risk of there being insufficient funds in the purchaser account at the time of a partial shipment is sufficiently low, the payment system 320 approves the transaction and guarantees the funds to the vendor 312.

The guarantee provided may be contingent on compliance by the vendor 312 with certain conditions, such as that shipments will be made within certain time limits. Thus at block 362, the payment system 320 periodically evaluates whether a time limit has passed. In different embodiments, such a time limit may correspond to a time limit between successive partial shipments or may correspond to an absolute time limit measured from the time of the transaction. If the time limit has passed, the vendor is notified at block 364 that that records for that transaction are to be closed and that the guarantee of payment for shipments associated with that transaction is being withdrawn. The records are then subsequently closed for that transaction at block 378.

If the time limit has not passed, the payment system 320 awaits notification from the vendor 312 at block 366 that a partial shipment has been made. Upon receipt of such a notification, the payment system 320 checks at block 368 whether sufficient funds to cover that shipment are currently in the purchaser account 332. If so, the payment system 320 initiates a transfer of the funds from the purchaser account 332 to the vendor account 336 at block 374. If the purchaser account 332 does not contain sufficient funds to cover the partial shipment, the payment system 320 transfers its own funds to the vendor account 336 at block 370 and subsequently seeks reimbursement of the paid amount from the purchaser 304 at block 372. The risk assessment performed at block 360 is intended to ensure that the level of defaults by purchasers is small. If it is discovered that the overall level of defaults is unacceptably high, approval criteria used with the risk assessment at block 360 may be adjusted to reduce the level of defaults. In instances where the risk assessment uses a dynamic model, feedback regarding the default level may be incorporated by the model automatically to refine approval criteria.

Once funds have been transferred to the vendor account 336, either directly from the payment system 320 or from the purchaser account 332, the payment system 320 determines at block 376 whether all items identified in the initial transaction have now been shipped. If not, the payment system 320 returns to a state in which it monitors compliance by the vendor 312 with time limits, awaiting notification of another partial shipment by the vendor 312. If the shipment is complete, the records for that transaction are closed at block 378.

The payment system 320 may impose service charges at one or more stages in the method outlined in FIG. 3B. For example, a general service charge may be imposed and collected from the purchaser account 332 after the payment system 320 performs the risk assessment at block 360 and guarantees payment for partial shipments. In addition, a transaction service charge may be imposed for each partial shipment by collecting the service charge at block 374 when arranging for a transfer of the payment amount between the purchaser and vendor accounts. A larger transaction service charge may be imposed if there are insufficient funds in the purchaser account 332 to cover a partial shipment by increasing the amount sought for reimbursement at block 372. A service charge may also be imposed at block 378 after the entire transaction has been completed.

In some instances, it may be desirable to combine the embodiments described with respect to FIG. 3B with those described with respect to FIG. 1C. In particular, in such embodiments, the payment system may maintain a surrogate account, but not require that it be used in all instances. If a risk assessment performed at the time of the transaction, such as at block 360 in FIG. 3B, provides a sufficiently high likelihood that funds will be available in the purchaser account at the time of partial shipments, the payment system may not require collection of any funds at that time. If that likelihood is not sufficiently high, funds may be collected at the time of the transaction and held in the surrogate account for distribution when partial shipments are made, as described with respect to FIG. 1C. A default by a particular purchaser will generally result in a greater likelihood that a surrogate account be used for future transactions involving that purchaser.

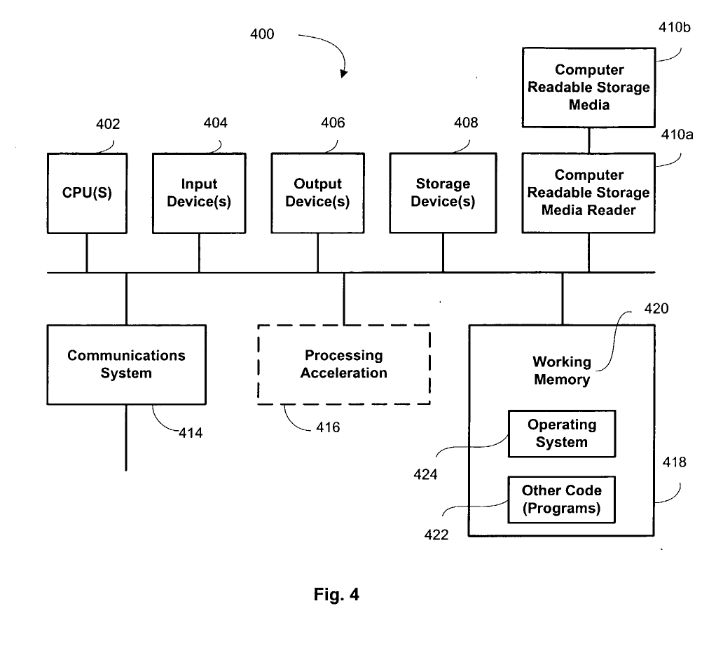

In some embodiments, the payment system is implemented on a computer system, a schematic illustration of which is shown in FIG. 4. This figure broadly illustrates how individual system elements may be implemented in a separated or more integrated manner. The payment system is denoted generally as 400 and is shown comprised of hardware elements that are electrically coupled via bus 426, including a processor 402, an input device 404, an output device 406, a storage device 408, a computer-readable storage media reader 410a, a communications system 414, a processing acceleration unit 416 such as a DSP or special-purpose processor, and a memory 418. The computer-readable storage media reader 410a is further connected to a computer-readable storage medium 410b, the combination comprehensively representing remote, local, fixed, and/or removable storage devices plus storage media for temporarily and/or more permanently containing computer-readable information. The communications system 414 may comprise a wired, wireless, modem, and/or other type of interfacing connection and permits data to be exchanged with the Internet, DTMF processor, cable processor, and/or financial institutions shown in FIGS. 1A, 2, or 3A.

The payment system 400 also comprises software elements, shown as being currently located within working memory 420, including an operating system 424 and other code 422, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

A computer system like the one described with respect to FIG. 4 may also be used by the vendor to coordinate providing the payment system with the payment instruction and with notifications of partial shipments as they are made.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for processing a transaction between a vendor and a purchaser, the method comprising:
receiving payment information for the transaction, wherein the payment information includes:
debit information identifying a purchaser account associated with the purchaser; and
identification of a vendor account associated with the vendor;
receiving notification from the vendor of a partial shipment in accordance with the transaction; and
effecting a transfer of funds from the purchaser account to the vendor account in accordance with the partial shipment.

2. The method recited in claim 1 wherein the transfer of funds from the purchaser account to the vendor account comprises a transfer of funds from the purchaser account to a surrogate account and a transfer of funds from the surrogate account to the vendor account.

3. The method recited in claim 2 wherein:
the transfer of funds from the purchaser account to the surrogate account occurs before receiving notification from the vendor of the partial shipment; and
the transfer of funds from the surrogate account to the vendor account occurs after receiving notification from the vendor of the partial shipment.

4. The method recited in claim 3 wherein:
the transfer of funds from the purchaser account to the surrogate account corresponds to a total payment amount for the transaction; and
the transfer of funds from the surrogate account to the vendor account corresponds to a partial payment amount for the partial shipment.

5. The method recited in claim 2 further comprising returning funds from the surrogate account to the purchaser account after a condition has been satisfied.

6. The method recited in claim 5 wherein the condition comprises a passage of a time period.

7. The method recited in claim 6 wherein the time period comprises a time period between successive partial shipments.

8. The method recited in claim 5 wherein the condition comprises an action taken by the purchaser.

9. The method recited in claim 1 wherein the transfer of funds is performed directly from the purchaser account to the vendor account.

10. The method recited in claim 9 wherein the transfer of funds is performed after receiving notification from the vendor of the partial shipment.

11. The method recited in claim 9 further comprising performing a risk assessment of a funds level in the purchaser account.

12. The method recited in claim 1 wherein the debit information is received from a debit card.

13. The method recited in claim 1 wherein the debit information is received from a computer-readable storage medium.

14. The method recited in claim 1 wherein the debit information comprises encrypted information, the method further comprising decrypting the encrypted information.

15. The method recited in claim 1 wherein the debit information is collected over the Internet.

16. The method recited in claim 1 wherein the debit information is collected with a point-of-sale device.

17. A computer system for processing a transaction between a vendor and a purchaser, the computer system comprising:
an input interface;
an output interface; and
a processor in communication with the input interface and the output interface, the processor being configured to:
receive payment information for the transaction at the input interface, wherein the payment information includes:
debit information identifying a purchaser account associated with the purchaser; and
identification of a vendor account associated with the vendor;
receive notification from the vendor of a partial shipment in accordance with the transaction; and
effect a transfer of funds from the purchaser account to the vendor account in accordance with the partial shipment.

18. The computer system recited in claim 17 wherein the transfer of funds from the purchaser account to the vendor account comprises a transfer of funds from the purchaser account to a surrogate account and a transfer of funds from the surrogate account to the vendor account.

19. The computer system recited in claim 18 wherein:
the transfer of funds from the purchaser account to the surrogate account occurs before receiving notification from the vendor of the partial shipment; and
the transfer of funds from the surrogate account to the vendor account occurs after receiving notification from the vendor of the partial shipment.

20. The computer system recited in claim 19 wherein:
the transfer of funds from the purchaser account to the surrogate account corresponds to a total payment amount for the transaction; and
the transfer of funds from the surrogate account to the vendor account corresponds to a partial payment amount for the partial shipment.

21. The computer system recited in claim 18 wherein the processor is further configured to return funds from the surrogate account to the purchaser account after passage of a time period.

22. The computer system recited in claim 17 wherein the transfer of funds is performed directly from the purchaser account to the vendor account.

23. The computer system recited in claim 22 wherein the transfer of funds is performed after receiving notification from the vendor of the partial shipment.

24. The computer system recited in claim 22 wherein the processor is further configured to perform a risk assessment of a funds level in the purchaser account.

25. The computer system recited in claim 17 wherein the debit information is received from a debit card.

26. The computer system recited in claim 17 wherein the debit information is received from a computer-readable storage medium.

27. The computer system recited in claim 17 wherein:
the debit information comprises encrypted information; and
the processor is further configured to decrypt the encrypted information.

28. The computer system recited in claim 17 wherein the input interface is configured for communication with the Internet.

29. The computer system recited in claim 17 wherein the input interface is configured for communication with a point-of-sale device.

30. A method for processing a transaction with a purchaser, the method comprising:
collecting an identification of a plurality of items from the purchaser;
collecting debit information from the purchaser, wherein the debit information identifies a purchaser account associated with the purchaser;
providing the debit information to a payment system; and
receiving funds coordinated by the payment system in response to a shipment of a portion of the plurality of items.

31. The method recited in claim 30 wherein the funds are received directly from a surrogate account controlled by the payment system.

32. The method recited in claim 30 wherein the funds are received directly from the purchaser account.

33. The method recited in claim 30 wherein the debit information is received from a debit card.

34. The method recited in claim 30 wherein the debit information is received from a computer-readable storage medium.

35. The method recited in claim 30 wherein the debit information is collected over the Internet.

36. The method recited in claim 30 wherein the debit information is collected with a point-of-sale device.

37. A computer system for processing a transaction with a purchaser, the computer system comprising:
an input interface;
an output interface; and
a processor in communication with the input interface and the output interface, the processor being configured to:
receive an identification of a plurality of items from the purchaser;
receive debit information from the purchaser, wherein the debit information identifies a purchaser account associated with the purchaser; and
issue a notification of a shipment of a portion of the plurality of items to effect receipt of funds from the purchaser account.

38. The computer system recited in claim 37 wherein the funds are received directly from a surrogate account controlled by the payment system.

39. The computer system recited in claim 37 wherein the funds are received directly from the purchaser account.

40. The computer system recited in claim 37 wherein the debit information is received from a debit card.

41. The computer system recited in claim 37 wherein the debit information is received from a computer-readable storage medium.

42. The computer system recited in claim 37 wherein the debit information is collected over the Internet.

43. The computer system recited in claim 37 wherein the debit information is collected with a point-of-sale device.
